(19) United States
(12) Patent Application Publication
(10) Pub. No.: US 2025/0380171 A1
(43) Pub. Date: Dec. 11, 2025

(54) INTERFERENCE HANDLING FOR FRAGMENTED CARRIERS

(71) Applicant: Apple Inc., Cupertino, CA (US)

(72) Inventors: Xiang Chen, Campbell, CA (US); Ankit Bhamri, Haar (DE); Dawei Zhang, Saratoga, CA (US); Haitong Sun, Saratoga, CA (US); Jie Cui, San Jose, CA (US); Manasa Raghavan, Sunnyvale, CA (US); Qiming Li, Beijing (CN); Yang Tang, San Jose, CA (US)

(73) Assignee: Apple Inc., Cupertino, CA (US)

(21) Appl. No.: 19/200,533

(22) Filed: May 6, 2025

Related U.S. Application Data
(60) Provisional application No. 63/657,035, filed on Jun. 6, 2024.

(51) Int. Cl. H04W 24/10; H04W 72/044

(52) U.S. Cl. CPC H04W 24/10; H04W 72/044

(57) ABSTRACT

The present application relates to devices and components including apparatus, systems, and methods to provide interference handling for fragmented carriers in wireless communication systems.

### CROSS-REFERENCE TO RELATED APPLICATION

This application claims priority to U.S. provisional application No. 63/657,035, entitled “Interference Handling for Fragmented Carriers,” filed on Jun. 6, 2024, the disclosure of which is incorporated by reference herein in its entirety for all purposes.

### TECHNICAL FIELD

The present application relates to the field of wireless technologies and, in particular, to interference handling for fragmented carriers of user equipments.

### BACKGROUND

Third Generation Partnership Project (3GPP) networks provide for user equipments (UEs) to utilize carriers for communicating with the networks. Carriers of a network can be assigned to different user equipments (UEs), where a UE can utilize the corresponding assigned carriers to communicate with the network. Different carriers can be assigned to different UEs within a same area, where the different UEs may utilize the corresponding assigned carriers to simultaneously communicate with the network.

### BRIEF DESCRIPTION OF THE DRAWINGS

FIG. 1 illustrates a network environment in accordance with some embodiments.

FIG. 2 illustrates a user equipment (UE) in accordance with some embodiments.

FIG. 3 illustrates a network device in accordance with some embodiments.

FIG. 4 illustrates example fragmented carrier arrangements in accordance with some embodiments.

FIG. 5 illustrates an example carrier gap arrangement in accordance with some embodiments.

FIG. 6 illustrates a procedure for configuring a UE in accordance with some embodiments.

FIG. 7 illustrates an example procedure for determining and reporting a blocker power level in accordance with some embodiments.

FIG. 8 illustrates an example procedure for configuring a UE in accordance with some embodiments.

FIG. 9 illustrates an example procedure for generating a report of a blocker power level in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

Third generation partnership project (3GPP) networks are developing to support fragmented carrier assignments to user equipments (UEs). For example, a network may assign a first range of frequency carriers and a second range of frequency carriers to a first UE for simultaneous communication. There may be a third range of frequency carriers (which can be referred to as a gap) between the first range of frequency carriers and the second range of frequency carriers that are not assigned to the first UE. This third range of frequency carriers can be assigned to other UEs to be utilized to communicate with the network. However, other UEs using the third range of frequency carriers to communicate can cause interference with communications on the first range of frequency carriers and/or the second range of frequency carriers that could result in operational issues. Approaches described throughout this disclosure may address this interference to ensure proper operation of the network.

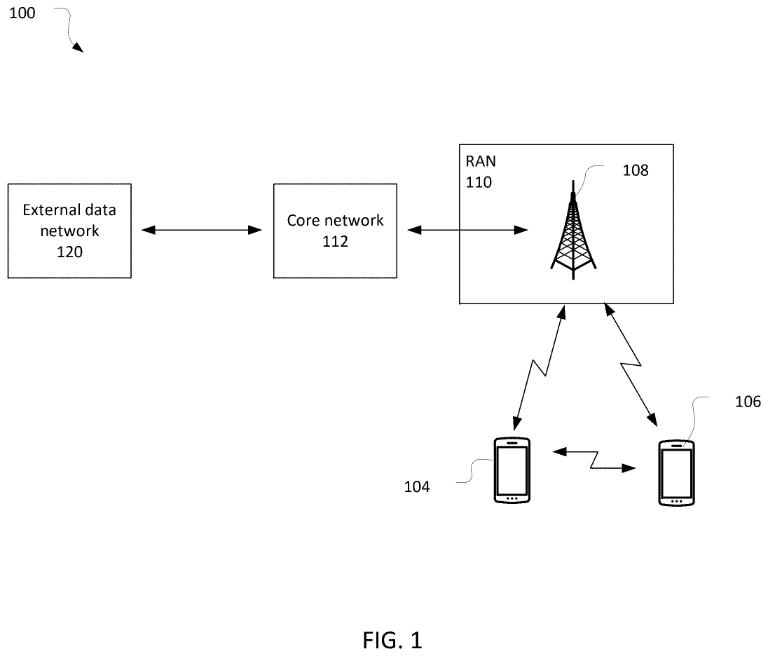

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

In some embodiments, the UE 104 and base station 108 may establish data radio bearers (DRBs) to support transmission of data over a wireless link between the two nodes. In one example, these DRBs may be used for traffic from extended reality (XR) applications that contains a large amount of data conveying real and virtual images and audio for presentation to a user.

The network environment 100 may further include a core network 112. For example, the core network 112 may comprise a 5th Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

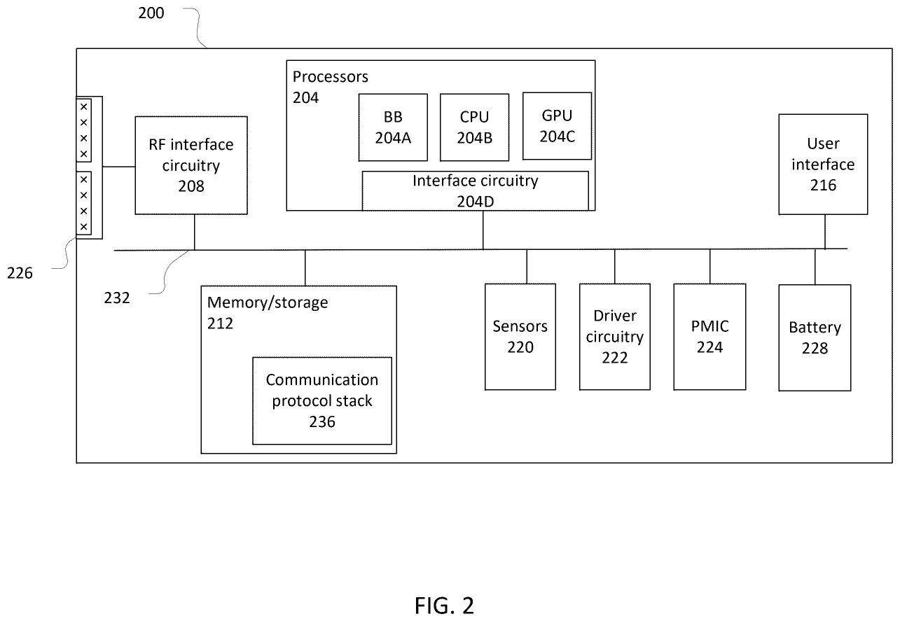

FIG. 2 illustrates a UE 200 in accordance with some embodiments. The UE 200 may be similar to and substantially interchangeable with UE 104 or 106.

The UE 200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 200 may include processors 204, RF interface circuitry 208, memory/storage 212, user interface 216, sensors 220, driver circuitry 222, power management integrated circuit (PMIC) 224, antenna 226, and battery 228. The components of the UE 200 may be implemented as integrated circuits (ICs), portions thereof, discrete electronic devices, or other modules, logic, hardware, software, firmware, or a combination thereof. The block diagram of FIG. 2 is intended to show a high-level view of some of the components of the UE 200. However, some of the components shown may be omitted, additional components may be present, and different arrangement of the components shown may occur in other implementations.

The components of the UE 200 may be coupled with various other components over one or more interconnects 232, which may represent any type of interface, input/output, bus (local, system, or expansion), transmission line, trace, or optical connection that allows various circuit components (on common or different chips or chipsets) to interact with one another.

The processors 204 may include processor circuitry such as, for example, baseband processor circuitry (BB) 204A, central processor unit circuitry (CPU) 204B, and graphics processor unit circuitry (GPU) 204C. The processors 204 may include any type of circuitry or processor circuitry that executes or otherwise operates computer-executable instructions, such as program code, software modules, or functional processes from memory/storage 212 to cause the UE 200 to perform delay-adaptive operations as described herein. The processors 204 may also include interface circuitry 204D to communicatively couple the processor circuitry with one or more other components of the UE 200.

In some embodiments, the baseband processor circuitry 204A may access a communication protocol stack 236 in the memory/storage 212 to communicate over a 3GPP compatible network. In general, the baseband processor circuitry 204A may access the communication protocol stack 236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 208.

The baseband processor circuitry 204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 212 may include one or more non-transitory, computer-readable media that includes instructions (for example, communication protocol stack 236) that may be executed by one or more of the processors 204 to cause the UE 200 to perform various delay-adaptive operations described herein.

The memory/storage 212 includes any type of volatile or non-volatile memory that may be distributed throughout the UE 200. In some embodiments, some of the memory/storage 212 may be located on the processors 204 themselves (for example, memory/storage 212 may be part of a chipset that corresponds to the baseband processor circuitry 204A), while other memory/storage 212 is external to the processors 204 but accessible thereto via a memory interface. The memory/storage 212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 208 may include transceiver circuitry and a radio frequency front module (RFEM) that allows the UE 200 to communicate with other devices over a radio access network. The RF interface circuitry 208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 226 and proceed to filter and amplify (with a low-noise amplifier) the signal. The signal may be provided to a receiver of the transceiver that down-converts the RF signal into a baseband signal that is provided to the baseband processor of the processors 204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 226.

In various embodiments, the RF interface circuitry 208 may be configured to transmit/receive signals in a manner compatible with NR access technologies.

The antenna 226 may include antenna elements to convert electrical signals into radio waves to travel through the air and to convert received radio waves into electrical signals. The antenna elements may be arranged into one or more antenna panels. The antenna 226 may have antenna panels that are omnidirectional, directional, or a combination thereof to enable beamforming and multiple input, multiple output communications. The antenna 226 may include microstrip antennas, printed antennas fabricated on the surface of one or more printed circuit boards, patch antennas, or phased array antennas. The antenna 226 may have one or more panels designed for specific frequency bands including bands in FR1 or FR2.

The user interface 216 includes various input/output (I/O) devices designed to enable user interaction with the UE 200. The user interface 216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 200.

The sensors 220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 222 may include software and hardware elements that operate to control particular devices that are embedded in the UE 200, attached to the UE 200, or otherwise communicatively coupled with the UE 200. The driver circuitry 222 may include individual drivers allowing other components to interact with or control various input/output (I/O) devices that may be present within, or connected to, the UE 200. For example, driver circuitry 222 may include a display driver to control and allow access to a display device, a touchscreen driver to control and allow access to a touchscreen interface, sensor drivers to obtain sensor readings of sensors 220 and control and allow access to sensors 220, drivers to obtain actuator positions of electro-mechanic components or control and allow access to the electro-mechanic components, a camera driver to control and allow access to an embedded image capture device, audio drivers to control and allow access to one or more audio devices.

The PMIC 224 may manage power provided to various components of the UE 200. In particular, with respect to the processors 204, the PMIC 224 may control power-source selection, voltage scaling, battery charging, or DC-to-DC conversion.

A battery 228 may power the UE 200, although in some examples the UE 200 may be mounted deployed in a fixed location and may have a power supply coupled to an electrical grid. The battery 228 may be a lithium ion battery, a metal-air battery, such as a zinc-air battery, an aluminum-air battery, a lithium-air battery, and the like. In some implementations, such as in vehicle-based applications, the battery 228 may be a typical lead-acid automotive battery.

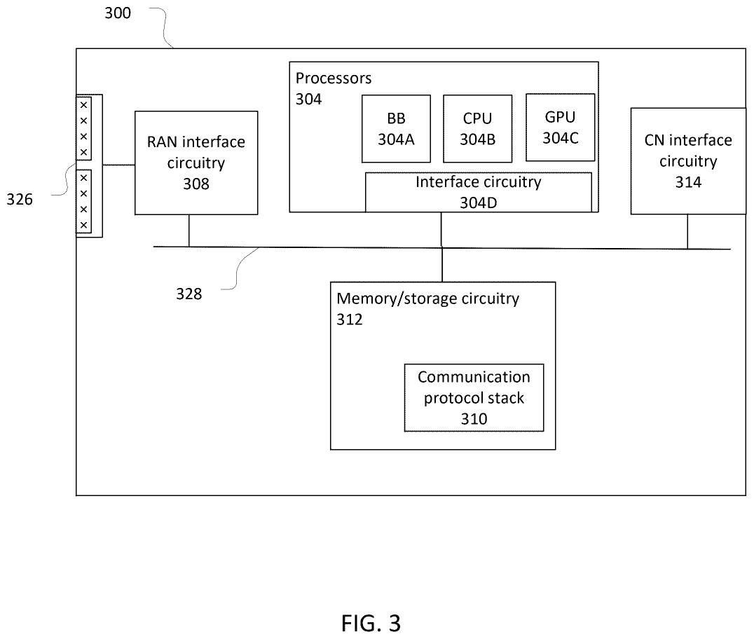

FIG. 3 illustrates a network device 300 in accordance with some embodiments. The network device 300 may be similar to and substantially interchangeable with base station 108 or a device of the core network 112 or external data network 120.

The network device 300 may include processors 304, RF interface circuitry 308 (if implemented as a base station), core network (CN) interface circuitry 314, memory/storage circuitry 312, and antenna structure 326.

The components of the network device 300 may be coupled with various other components over one or more interconnects 328.

The processors 304, RF interface circuitry 308, memory/storage circuitry 312 (including communication protocol stack 310), antenna structure 326, and interconnects 328 may be similar to like-named elements shown and described with respect to FIG. 2.

The processors 304 may include processor circuitry such as, for example, baseband processor circuitry (BB) 304A, central processor unit circuitry (CPU) 304B, and graphics processor unit circuitry (GPU) 304C. The processors 304 may include any type of circuitry or processor circuitry that executes or otherwise operates computer-executable instructions, such as program code, software modules, or functional processes from memory/storage circuitry 312 to cause the network device 300 to perform operations described herein. The processors 304 may also include interface circuitry 304D to communicatively couple the processor circuitry with one or more other components of the network device 300.

The CN interface circuitry 314 may provide connectivity to a core network, for example, a 5th Generation Core network (5GC) using a 5GC-compatible network interface protocol such as carrier Ethernet protocols, or some other suitable protocol. Network connectivity may be provided to/from the network device 300 via a fiber optic or wireless backhaul. The CN interface circuitry 314 may include one or more dedicated processors or FPGAs to communicate using one or more of the aforementioned protocols. In some implementations, the CN interface circuitry 314 may include multiple controllers to provide connectivity to other networks using the same or different protocols.

In release 19 (R19), support of fragmented carriers in the downlink (DL) may be introduced. As issue to be addressed is how to consider fragmented intra-band blocks as a single component carrier (CC) in the DL. The scope may be limited to frequency division duplex (FDD) bands, where individual DL bandwidth may be less than or equal to 100 megahertz (MHz). The feasibility of using a single reception (Rx) chain per fragmented FDD band may be evaluated, while the near-far problem and unwanted emissions implications may be considered.

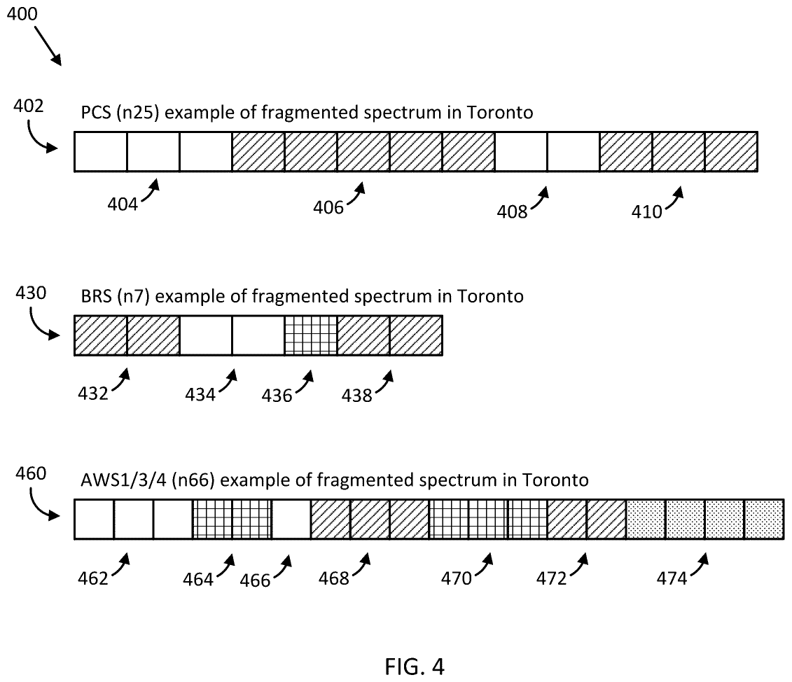

FIG. 4 illustrates example fragmented carrier arrangements 400 in accordance with some embodiments. For example, the arrangements 400 illustrate some example carrier assignments with non-contiguous carrier groups being assigned to a same UE. Each of the blocks within the illustrated arrangements 400 represent 5 MHz spectrum, where blocks with the same fill represent carrier(s) assigned to a same UE. For example, a same fill indicates spectrum access for a same operator. Each of the blocks is 5 MHz wide in the illustrated embodiment.

The arrangements 400 include a first fragmented carrier arrangement 402. The first arrangement 402 may include a personal communications services (PCS) (n25) example of segmented spectrum, which can be for Toronto in the illustrated embodiment. The first arrangement 402 includes a first group of carrier(s) 404, a second group of carrier(s) 406, a third group of carrier(s) 408, and a fourth group of carrier(s) 410. The first group of carrier(s) 404 and the third group of carrier(s) 408 may be assigned to a first operator (as illustrated by the corresponding blocks having no fill), which can assign the first group of carrier(s) 404 and the third group of carrier(s) 408 to a first UE. The second group of carrier(s) 406 and the fourth group of carrier(s) 410 may be assigned to a second operator (as illustrated by the corresponding blocks having a diagonal line fill), which can assign the second group of carrier(s) 406 and the fourth group of carrier(s) 410 to a second UE.

The first group of carrier(s) 404 and the third group of carrier(s) 408 are separated by the second group of carrier(s) 406, thereby causing the first group of carrier(s) 404 and the third group of carrier(s) 408 to be non-contiguous. As both the first group of carrier(s) 404 and the third group of carrier(s) 408 are assigned to the first operator, the carrier(s) may be a fragmented carrier assignment to the first operator. The second group of carrier(s) 406 and the fourth group of carrier(s) 410 are separated by the third group of carrier(s) 408, thereby causing the second group of carrier(s) 406 and the fourth group of carrier(s) 410 to be non-contiguous. As both the second group of carrier(s) 406 and the fourth group of carrier(s) 410 are assigned to the second operator, the carrier(s) may be a fragmented carrier assignment to the second operator. The carrier(s) between the fragmented carrier(s) in the fragmented carrier assignments could cause interference with the fragmented carrier(s). Legacy network implementations did not address this interference possibility for fragmented carrier(s).

The arrangements 400 include a second fragmented carrier arrangement 430. The second arrangement 430 may include a broadband radio services (BRS) (n7) example of segmented spectrum, which can be for Toronto in the illustrated embodiment. The second arrangement 430 includes a first group of carrier(s) 432, a second group of carrier(s) 434, a third group of carrier(s) 436, and a fourth group of carrier(s) 438. The first group of carrier(s) 432 and the fourth group of carrier(s) 438 may be assigned to a first operator (as illustrated by the corresponding blocks having diagonal line fill), which can assign the first group of carrier(s) 432 and the fourth group of carrier(s) 438 to a first UE. The second group of carrier(s) 434 may be assigned to a second operator (as illustrated by the corresponding blocks having no fill), which can assign the second group of carrier(s) 434 to a second UE. The third group of carrier(s) 436 may be assigned to a third operator (as illustrated by the corresponding blocks having a crosshatch fill), which can assign the third group of carrier(s) 436 to a third UE.

The first group of carrier(s) 432 and the fourth group of carrier(s) 438 are separated by the second group of carrier(s) 434 and the third group of carrier(s) 436, thereby causing the first group of carrier(s) 432 and the fourth group of carrier(s) 438 to be non-contiguous. As both the first group of carrier(s) 432 and the fourth group of carrier(s) 438 are assigned to the first operator, the carrier(s) may be a fragmented carrier assignment to the first operator. The carrier(s) between the fragmented carriers in the fragmented carrier assignments could cause interference with the fragmented carriers. Legacy network implementations did not address this interference possibility for fragmented carriers.

The arrangements 400 include a third fragmented carrier arrangement 460. The third arrangement 460 may include an advanced wireless services (AWS) 1/3/4 (n66) example of segmented spectrum, which can be for Toronto in the illustrated embodiment. The third arrangement 460 includes a first group of carrier(s) 462, a second group of carrier(s) 464, a third group of carrier(s) 466, a fourth group of carrier(s) 468, a fifth group of carrier(s) 470, a sixth group of carrier(s) 472, and a seventh group of carrier(s) 474. The first group of carrier(s) 462 and the third group of carrier(s) 466 may be assigned to a first operator (as illustrated by the corresponding blocks having no fill), which can assign the first group of carrier(s) 462 and the third group of carrier(s) 466 to a first UE. The second group of carrier(s) 464 and the fifth group of carrier(s) 470 may be assigned to a second operator (as illustrated by the corresponding blocks having a crosshatch fill), which can assign the second group of carrier(s) 464 and the fifth group of carrier(s) 470 to a second UE. The fourth group of carrier(s) 468 and the sixth group of carrier(s) 472 may be assigned to a third operator (as illustrated by the corresponding blocks having a diagonal line fill), which can assign the fourth group of carrier(s) 468 and the sixth group of carrier(s) 472 to a third UE. The seventh group of carrier(s) 474 may be assigned to a fourth operator (as illustrated by the corresponding blocks having a dotted fill), which can assign the seventh group of carrier(s) 474 to a fourth UE.

The first group of carrier(s) 462 and the third group of carrier(s) 466 are separated by the second group of carrier(s) 464, thereby causing the first group of carrier(s) 462 and the third group of carrier(s) 466 to be non-contiguous. As both the first group of carrier(s) 462 and the third group of carrier(s) 466 are assigned to the first operator, the carrier(s) may be a fragmented carrier assignment to the first operator. The second group of carrier(s) 464 and the fifth group of carrier(s) 470 are separated by the third group of carrier(s) 466 and the fourth group of carrier(s) 468, thereby causing the second group of carrier(s) 464 and the fifth group of carrier(s) 470 to be non-contiguous. As both the second group of carrier(s) 464 and the fifth group of carrier(s) 470 are assigned to the second operator, the carriers may be a fragmented carrier assignment to the second operator. The fourth group of carrier(s) 468 and the sixth group of carrier(s) 472 are separated by the fifth group of carrier(s) 470, thereby causing the fourth group of carrier(s) 468 and the sixth group of carrier(s) 472 to be non-contiguous. As both the fourth group of carrier(s) 468 and the sixth group of carrier(s) 472 are assigned to the third operator, the carriers may be a fragmented carrier assignment to the third operator. The carriers between the fragmented carriers in the fragmented carrier assignments could cause interference with the fragmented carriers. Legacy network implementations did not address this interference possibility for fragmented carriers.

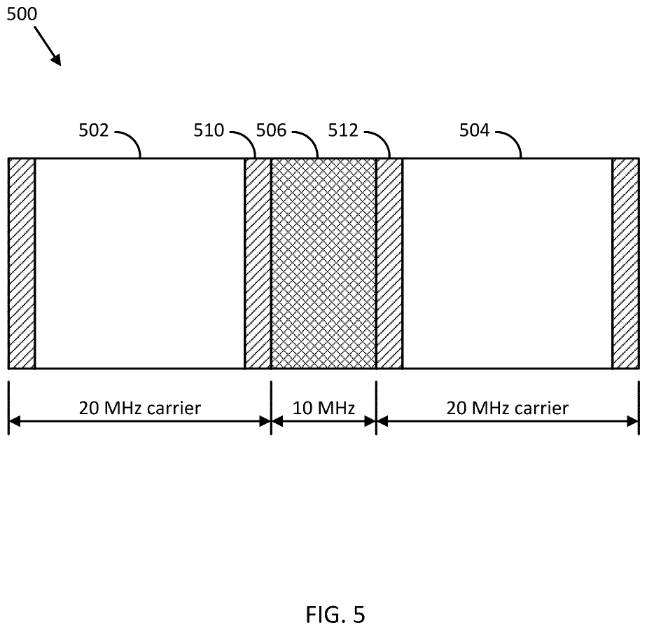

FIG. 5 illustrates an example carrier gap arrangement 500 in accordance with some embodiments. The arrangement 500 illustrates an example of a fragment carrier assignment with a gap between the fragmented carriers.

The arrangement 500 includes a first group of carrier(s) 502 and a second group of carrier(s) 504. The first group of carrier(s) 502 and the second group of carrier(s) 504 may be assigned to a first UE. Each of the first group of carrier(s) 502 and the second group of carrier(s) 504 may include one or more carriers. In the illustrated embodiment, each of the first group of carrier(s) 502 and the second group of carrier(s) 504 may include a 20 MHz carrier. In the illustrated embodiment, the first group of carrier(s) 502 may include four carriers and the second group of carrier(s) 504 may include four carriers.

The arrangement 500 may include a gap 506 between the first group of carrier(s) 502 and the second group of carrier(s) 504. In the illustrated embodiment, the gap 506 may be 10 MHz. There is likely other operators operating in the gap between the two adjacent frequency blocks, presenting strong interferer/blocker. Carrier(s) within the gap may not be assigned to first UE. In some embodiments, a portion of the carrier(s) within the gap 506 may be assigned to other UEs. For example, the portion of the carrier(s) may be assigned to a second UE in the illustrated embodiment. The portion of the carrier(s) assigned to another UE may be referred to as an interferer and/or blocker. Accordingly, the arrangement 500 may have an interferer/blocker in the gap 506.

The arrangement 500 may include guard bands in the first group of carrier(s) 502, and/or the second group of carrier(s) 504. For example, the first group of carrier(s) 502 and the second group of carrier(s) 504 may include guard bands at the edges of the carriers adjacent to the gap 506 that includes the interferer/blocker. The first group of carrier(s) 502 includes a first guard band 510 at an edge of the first group of carrier(s) 502 adjacent to the interferer/blocker, and the second group of carrier(s) 504 includes a second guard band 512 at an edge of the second group of carrier(s) 504 adjacent to the interferer/blocker in the illustrated embodiment. The carrier(s) within the guard bands may be unassigned and may provide some protection from interference between the interferer/blocker, the first group of carrier(s) 502, and/or the second group of carrier(s) 504.

As there can be a blocker sitting between the two frequency blocks, which may cause strong interference to the DL reception, it is imperative to deal with the interference in order to support the fragmented carrier operation. In this disclosure, the following approaches address interference. The approaches may include one or more of UE detection of the blocker, UE reporting of the blocker, UE capability reporting on simultaneous reception of two or more frequency blocks in the DL (the Blocker may be closer to one frequency blocker than to the other), and/or network configuration and scheduling based on UE reporting.

Approaches described herein may implement detection of the blocker. Before scheduling, the network may configure inter-frequency (new radio (NR))/inter-radio access technology (RAT) (long term evolution (LTE)) measurement to a UE for the adjacent channels (i.e., channels operating in the gap between two frequency blocks). For example, a base station may configure the first UE that is assigned the first group of carrier(s) 502 and the second group of carrier(s) 504, and/or generate a configuration to cause the first UE, to measure the interferer/blocker between the first group of carrier(s) 502 and the second group of carrier(s) 504. The base station may configure a UE to measure new radio (NR) carrier received signal strength indicator (RSSI) for NR. Alternatively, the base station may configure a UE to measure evolved universal terrestrial radio access (E-UTRA) carrier RSSI for LTE.

Based on the measured RSSI and the channel bandwidth information read from the master information block (MIB)/system information block (SIB), the UE can derive the blocker power level through scaling and report it to the network. For NR, channel bandwidth can be read from system information block 1 (SIB1). For LTE, channel bandwidth can be read from MIB. Estimated blocker power level=Measured RSSI*channel bandwidth/RSSI measurement bandwidth. For example, the UE may estimate a blocker power level for the interferer/blocker based at least in part on a measured RSSI, a channel bandwidth, and/or an RSSI measurement bandwidth. The UE may estimate the blocker power level to be

$$Estimated blocker power level = Measured RSSI \times \frac{channel bandwidth}{RSSI measurement bandwidth} .$$

Approaches described herein may implement reporting of the blocker power level. For a first option (“Option 1”) on the reporting mechanism, it can be configured as periodic/aperiodic/event-triggered by the network. For example, a base station may configure a UE to report the estimated blocker power level periodically, aperiodically, or as triggered by occurrence of an event.

The reporting periodicity can be configured based on UE mobility. For example, the base station may determine a speed at which the UE is moving. The base station may determine a periodicity for the reporting of a UE based on the determined speed of the UE. For example, the base station may determine that a periodicity of the reporting for a UE is to be a first periodicity when a speed of travel is over a threshold value and that a periodicity of the reporting for a UE is to be a second periodicity when a speed of travel is under the threshold value, where the first periodicity is more frequent than the second periodicity. In other embodiments, the base station may have defined speed ranges with corresponding threshold values, where the period is shorter for higher speed ranges. The base station may configure the UE with the determined periodicity.

In some embodiments where the reporting is triggered by the occurrence of the event, the event can be the blocker level change is greater than a threshold, where threshold can be preconfigured by the network through radio resource control (RRC). For example, the base station may configure the UE with a blocker level change threshold value. The UE may determine an estimated blocker power level. The UE may compare the estimated power blocker power level to a last reported blocker power level to determine a difference between the values. The UE may compare the difference to the blocker level change threshold value to determine whether the difference is greater than the blocker level change threshold value. The UE may generate and/or transmit a report of the blocker power level to the base station.

Reporting can be done via uplink control information (UCI)/medium access control (MAC) control element (CE)/RRC. For example, the UE may transmit reports indicating the determined blocker power level to the base station via UCI, MAC CE, or RRC.

For a second option (which may be referred to as “Option 2”), the reporting may be configured by RRC and based on MAC CE, with the following information elements (IEs):

```
BlockerPowerReport-Config :: = {
  bpr-PeriodicTimer ENUMERATED {timer 1, timer 2, ..., infinity},
  bpr-ProhibitTimer ENUMERATED {timer 1, timer 2, ...},
  bpr-PowerFactorChange ENUMERATED {xdB, ydB, zdB, ...,
  infinity},
}
```

For example, the base station may generate and/or transmit a blocker power report IE to the UE to configure the UE for blocker power reporting. The blocker power report may include a periodic timer IE, a prohibit timer IE, and/or a power factor change IE. The periodic timer IE may be utilized for configuring a periodic timer of the UE for reporting, where the UE may transmit a blocker power report at the expiration of the periodic timer. The prohibit timer IE may be utilized for configuring a prohibit timer of the UE for reporting, where the UE may be prevented from transmitting a blocker report until the prohibit timer has expired. The power factor change IE may be utilized for configuring a blocker level change threshold value for determining whether to report the blocker power level, as described above.

Approaches described herein may implement UE capability reporting. UE may indicate its capability if it can be scheduled simultaneously with two or more frequency blocks. For example, the UE may provide an indication to a base station whether the UE supports simultaneously scheduled fragmented carriers.

In a first option (which may be referred to as “Option 1”), a UE may indicate how many discontinuous frequency blocks can be simultaneously scheduled in the downlink DL, with the gap between any two adjacent frequency blocks being 5 MHz or larger. For example, a UE may determine how many discontinuous frequency blocks the UE supports with a guard band of 5 MHz or larger. The UE may generate and/or transmit a capability information report than indicates the determined number of discontinuous frequency blocks supported.

In a second option (which may be referred to as “Option 2:), besides the number of discontinuous frequency blocks, UE can further indicate the maximum blocker power level in a gap it can handle while supporting simultaneous DL scheduling. For example, in addition to the capability information report indicating the determined number of frequency blocks supported, the capability information report may include an indication of a maximum blocker power level for a blocker in a gap between the discontinuous frequency blocks supported.

In a first approach of the second option (which may be referred to as “Option 2.1”), the UE can further indicate several levels of maximum blocker power levels in a gap it can handle while supporting simultaneous DL scheduling, together with the corresponding required guard band (GB), which are larger than the minimum GB specified in the specification. For example, the UE may determine one or more ranges of blocker power levels. The UE may further determine a guard band size for each of the ranges of blocker power levels. The UE may indicate (such as within the capability information report) the ranges of blocker power levels and the corresponding guard band sizes for each of the ranges of blocker power levels. For example, the guard band sizes indicated may define sizes for the first guard band 510 (FIG. 5) and/or the second guard band 512 (FIG. 5).

As an example in some embodiments, the UE may indicate the following: P0 decibel milliwatts (dBm) less than or equal to Blocker power less than P1 dBm, GB1; P1 dBm less than or equal to Blocker power less than P2 dBm, GB2; P2 dBm less than or equal to Blocker power less than P3 dBm, GB3, . . . . Accordingly, the UE may indicate that a guard band size is to be GB1 for blocker power levels between 0 dBm and P1 dBm, a guard band size is to be GB2 for blocker power levels between P1 dBm and P2 dBm, a guard band size is to be GB3 for blocker power levels between the P2 dBm and P3 dBm, and so on.

As multi-block scheduling is for DL, the GB for DL and uplink (UL) can be different. For example, the GB for DL can be larger than nominal GB, while GB for UL can remain as the nominal GB in some embodiments.

Approaches described herein may implement network configuration and scheduling. A number of GB sizes can be specified and the network can configure it to the UE by RRC. For example, a base station may determine sizes for guard bands, such as the first guard band 510 (FIG. 5) and/or the second guard band 512 (FIG. 5). The base station may generate and/or transmit a configuration to the UE that configures the UE with one or more guard bands with the determined sizes.

In a first option, depending on the UE's capability and blocker power reporting, the network can use RRC or MAC CE to change the GB setting. For example, the base station may receive capability information and/or blocker power levels reported by the UE. The base station may determine GB sizes for the UE based on the capability information and/or the blocker power levels reported by the UE. If the determined GB sizes are different than a current GB size, the base station may generate and/or transmit a configuration update to the UE that indicates that the UE is to update the GBs. UE requirement, such as GB setting change delay, can be specified to allow time for UE filter adaptation time. For example, the base station may implement a delay in the updating of the GB sizes to allow for UE filter adaptation.

In a second option, the network does not explicitly configure GB setting to the UE. Instead, the network may schedule the UE with RB allocations that always meet the required GB. For example, the base station may determine GB sizes for the UE based on the capability information and/or the blocker power levels reported by the UE. The base station may schedule the UE with RB allocations avoiding the determined GB sizes without explicitly configuring the UE with the determined GB sizes.

If blocker power level is too high, the network can fall back to schedule only one frequency block to such UEs. For example, the base station may determine whether a blocker power level of a blocker/interferer exceeds a supported blocker power level of the UE. If the base station determines that the blocker power level exceeds the supported blocker power level, the base station may determine that the UE is to be configured with one frequency block rather than two or more non-contiguous frequency blocks. The base station may then generate and/or transmit a configuration to the UE to configure the UE with one frequency block rather than two or more frequency blocks.

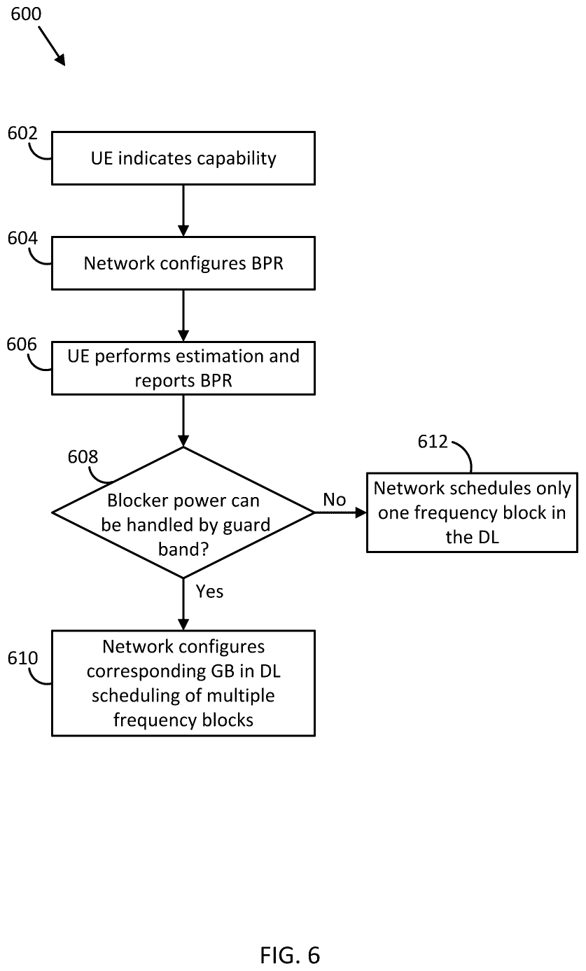

FIG. 6 illustrates a procedure 600 for configuring a UE in accordance with some embodiments. For example, the procedure 600 may implement one or more of the approaches described throughout the disclosure.

The procedure 600 may include the UE indicating capability in 602. For example, the UE may indicate the UE capability to a base station as described throughout this disclosure. The UE may generate and/or transmit a capability information message to the base station that indicates the frequency blocks supported by the UE and/or the guard band information as described throughout this disclosure.

The procedure 600 may include the network configuring blocker power reporting in 604. For example, the base station may configure the UE to perform blocker power level measurements and/or report blocker power level measurement results in accordance with the approaches described herein.

The procedure 600 may include the UE performing estimation and reporting blocker power reporting in 606. For example, the UE may measure an RSSI and estimate blocker power levels for a blocker/interferer in accordance with the approaches described herein. Further, the UE may report the blocker power levels in accordance with the configuration of 604.

The procedure 600 may include determining whether the blocker power can be handled by guard band in 608. For example, the base station may determine whether the UE supports a blocker level power based on the capability information indicated in 602. The base station may determine the blocker level power based on the estimated blocker power level reported by the UE in 606.

If the base station determines that the blocker power can be handled by guard bands in 608, the procedure 600 may proceed to 610. The procedure 600 may include the network configuring corresponding guard band in DL scheduling of multiple frequency blocks in 610. For example, the base station may determine appropriate frequency blocks and/or guard bands for the UE based on the blocker power level in accordance with the approaches described herein. The base station may configure the UE with the determined frequency blocks and/or guard bands.

If the base station determines that the blocker power cannot be handled by guard bands, the procedure 600 may proceed to 612. The procedure 600 may include the network scheduling only one frequency block in the DL in 612. For example, the base station may configure the UE with a single frequency block.

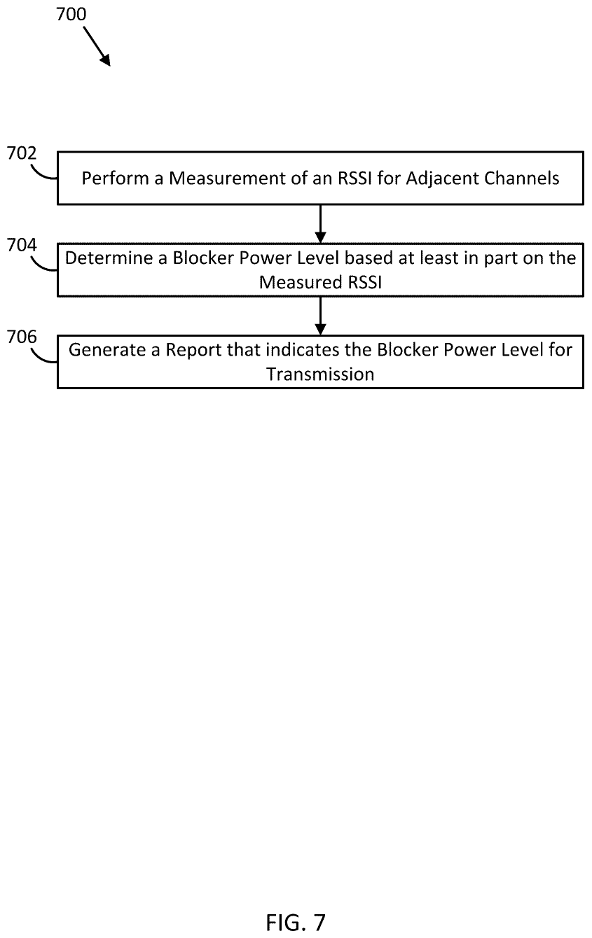

FIG. 7 illustrates an example procedure 700 for determining and reporting a blocker power level in accordance with some embodiments. The procedure 700 may be performed by a UE, such as the UE 104 (FIG. 1), the UE 106 (FIG. 1), and/or the UE 200 (FIG. 2).

The procedure 700 may include performing a measurement of an RSSI for adjacent channels in 702. For example, the UE may perform a measurement of an RSSI for adjacent channels operating in a gap between two frequency blocks to be configured for a UE.

The procedure 700 may include determining a blocker power level based at least in part on the measured RSSI in 704. In some embodiments, the procedure 700 may further include reading a channel bandwidth corresponding to the adjacent channels, wherein the blocker power level is further determined based at least in part on the channel bandwidth.

The procedure 700 may include generating a report that indicates the blocker power level for transmission in 706. In some embodiments, the procedure 700 may further include identifying a blocker power report configuration to configure blocker power level reporting. The blocker power report configuration may include a periodic timer information element to configure a periodic timer for the blocker power level reporting, a prohibit timer information element to configure a prohibit timer for the blocker power level reporting, or a power factor change information element to configure a threshold power level difference for the blocker power level reporting.

In some embodiments, the procedure 700 may further include generating a capability indication for transmission. The capability indication may indicate how many discontinuous frequency blocks can be simultaneously scheduled in downlink (DL). In some of these embodiments, the capability indication may further indicate a maximum blocker power level for the gap while supporting simultaneous DL scheduling. Further, the capability indication further may indicate a first minimum guard band for a first blocker power range, and a second minimum guard band for a second blocker power range in some embodiments.

In some embodiments, the procedure 700 may further include identifying a guard band configuration received from a base station, and adapting a filter for the gap based at least in part on the guard band configuration.

In some embodiments, the procedure 700 may further include performing additional RSSI measurements for the adjacent channels, and determining one or more additional blocker power levels based at least in part on the additional RSSI measurements. The procedure 700 may further include periodically generating one or more reports indicating the one or more additional blocker power levels for transmission.

In some embodiments, the procedure 700 may further include performing an additional RSSI measurement for the adjacent channels, and determining an additional blocker power level based at least in part on the additional RSSI measurement. The procedure 700 may further include determining a difference between the additional blocker power level and the blocker power level, determining whether the difference exceeds a threshold power level difference, and determining whether to generate an additional report indicating the additional blocker power level for transmission based at least in part on whether the difference is determined to exceed the threshold power level difference.

Any one or more of the operations in FIG. 7 may be performed in a different order than shown and/or one or more of the operations may be performed concurrently in embodiments. Further, it should be understood that one or more of the operations may be omitted from and/or one or more additional operations may be added to the procedure 700 in other embodiments.

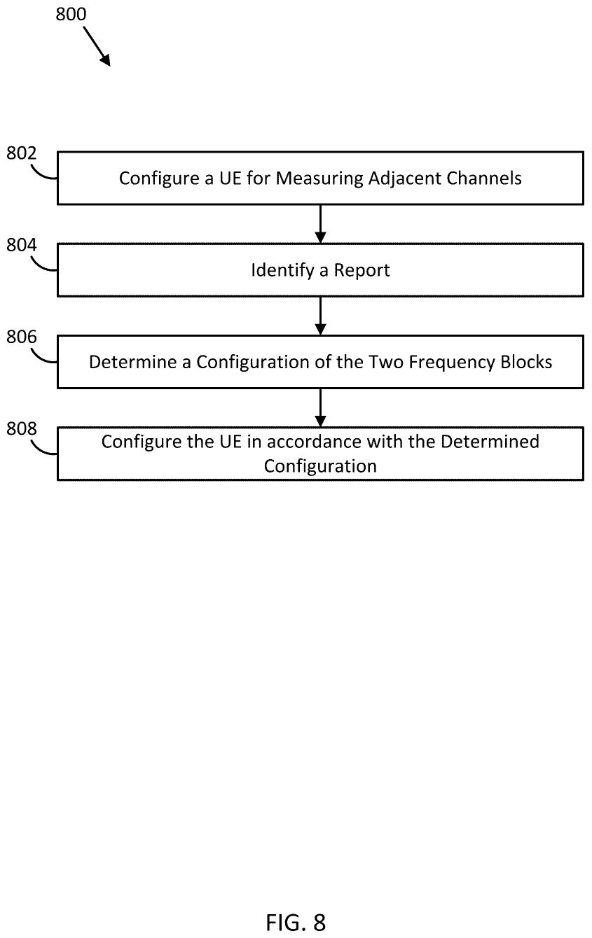

FIG. 8 illustrates an example procedure 800 for configuring a UE in accordance with some embodiments. The procedure 800 may be performed by a base station, such as the base station 108 (FIG. 1) and/or the network device 300 (FIG. 3).

The procedure 800 may include configuring a UE for measuring adjacent channels in 802. For example, the base station may configure a user equipment (UE) for measuring adjacent channels operating in a gap between two frequency blocks to be configured for the UE.

In some embodiments, configuring the UE for measuring the adjacent channels may include configuring the UE for inter-frequency measurement for the adjacent channels, or configuring the UE for inter-radio access technology (RAT) measurement for the adjacent channels.

In some embodiments, configuring the UE for measuring the adjacent channels may include configuring the UE to measure a new radio (NR) carrier received signal strength indicator (RSSI) of the adjacent channels, or configuring the UE to measure an evolved universal terrestrial radio access (E-UTRA) carrier RSSI of the adjacent channels.

In some embodiments, the procedure 800 may further include configuring the UE to periodically report blocker power levels for the adjacent channels, or configuring the UE to report blocker power levels for the adjacent channels when a change in the blocker power levels exceeds a threshold.

In some embodiments, the procedure 800 may further include generating a blocker power report configuration for transmission to the UE. The blocker power report configuration may include a periodic timer information element to configure a periodic timer for the blocker power level reporting, a prohibit timer information element to configure a prohibit timer for the blocker power level reporting, or a power factor change information element to configure a threshold power level difference for the blocker power level reporting.

In some embodiments, the procedure 800 may further include identifying a capability indication message received from the UE. The capability indication message may include an indication of an amount of discontinuous frequency blocks simultaneously schedulable in downlink for the UE, wherein the configuration is determined based at least in part on the amount of discontinuous frequency blocks indicated. In some of these embodiments, the capability indication message may further include a maximum blocker power level for the gap, wherein the configuration is further determined based at least in part on the maximum blocker power level. In some of these embodiments, the procedure 800 may further include configuring a guard band for the gap based at least in part on capability information from the capability indication message and the blocker power level. In other of these embodiments, the procedure 800 may further include scheduling resource block allocations for the UE based at least in part on capability information from the capability indication message and the blocker power level.

The procedure 800 may include identifying a report in 804. For example, the base station may identify a report received from the UE. The report may indicate a blocker power level for the adjacent channels.

The procedure 800 may include determining a configuration of the two frequency blocks in 806. For example, the base station may determine a configuration of the two frequency blocks for the UE based at least in part on the blocker power level.

The procedure 800 may include configuring the UE in accordance with the determined configuration in 808.

Any one or more of the operations in FIG. 8 may be performed in a different order than shown and/or one or more of the operations may be performed concurrently in embodiments. Further, it should be understood that one or more of the operations may be omitted from and/or one or more additional operations may be added to the procedure 800 in other embodiments.

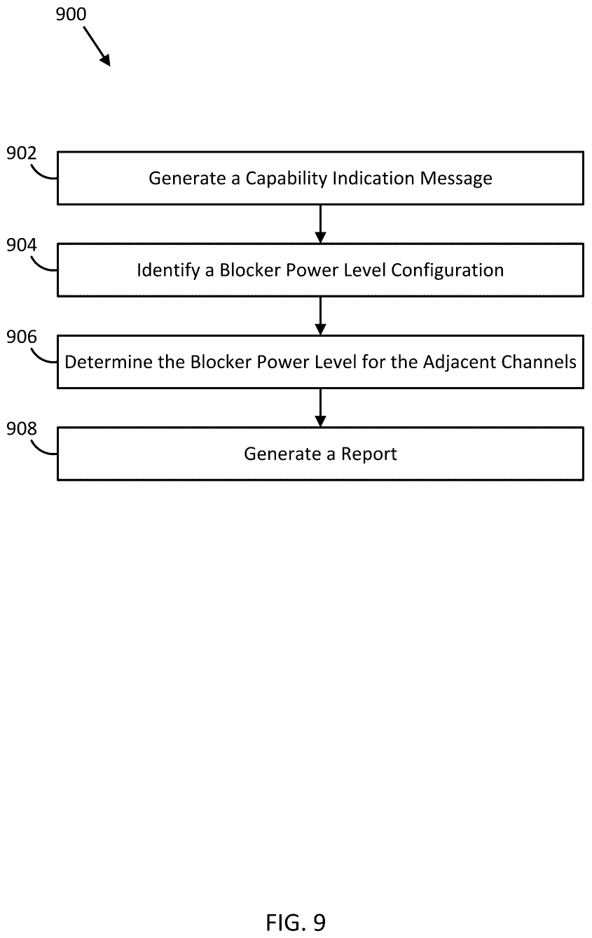

FIG. 9 illustrates an example procedure 900 for generating a report of a blocker power level in accordance with some embodiments. The procedure 900 may be performed by a UE, such as the UE 104 (FIG. 1), the UE 106 (FIG. 1), and/or the UE 200 (FIG. 2).

The procedure 900 may include generating a capability indication message for transmission to a base station in 902. The capability indication message may include an indication of an amount of discontinuous frequency block supported for simultaneous scheduling in downlink (DL).

In some embodiments, the capability indication message may further include a maximum blocker power level for the gap while supporting simultaneous in the DL, or an indication of one or more minimum guard bands for one or more blocker power ranges.

The procedure 900 may include identifying a blocker power level configuration in 904. For example, the UE may identify a blocker power level configuration for measuring a blocker power level for adjacent channels operating in a gap between two frequency blocks configurable for a user equipment.

The procedure 900 may include determining the blocker power level for the adjacent channels in 906. For example, the UE may determine the blocker power level for the adjacent channels in accordance with the blocker power level configuration. In some embodiments, the blocker power level may include performing a measurement of a received signal strength indicator (RSSI) for the adjacent channels, wherein the blocker power level is determined at least in part on the measured RSSI.

The procedure 900 may include generating a report in 908. For example, the UE may generate a report that indicates the blocker power level for transmission.

Any one or more of the operations in FIG. 9 may be performed in a different order than shown and/or one or more of the operations may be performed concurrently in embodiments. Further, it should be understood that one or more of the operations may be omitted from and/or one or more additional operations may be added to the procedure 900 in other embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method comprising performing a measurement of a received signal strength indicator (RSSI) for adjacent channels operating in a gap between two frequency blocks to be configured for a user equipment (UE), determining a blocker power level based at least in part on the measured RSSI, and generating a report that indicates the blocker power level for transmission.

Example 2 may include the method of example 1, further comprising reading a channel bandwidth corresponding to the adjacent channels, wherein the blocker power level is further determined based at least in part on the channel bandwidth.

Example 3 may include the method of example 1, further comprising performing additional RSSI measurements for the adjacent channels, determining one or more additional blocker power levels based at least in part on the additional RSSI measurements, and periodically generating one or more reports indicating the one or more additional blocker power levels for transmission.

Example 4 may include the method of example 1, further comprising performing an additional RSSI measurement for the adjacent channels, determining an additional blocker power level based at least in part on the additional RSSI measurement, determining a difference between the additional blocker power level and the blocker power level, determining whether the difference exceeds a threshold power level difference, and determining whether to generate an additional report indicating the additional blocker power level for transmission based at least in part on whether the difference is determined to exceed the threshold power level difference.

Example 5 may include the method of example 1, further comprising identifying a blocker power report configuration to configure blocker power level reporting, the blocker power report configuration including a periodic timer information element to configure a periodic timer for the blocker power level reporting, a prohibit timer information element to configure a prohibit timer for the blocker power level reporting, or a power factor change information element to configure a threshold power level difference for the blocker power level reporting.

Example 6 may include the method of example 1, further comprising generating a capability indication for transmission, the capability indication indicates how many discontinuous frequency blocks can be simultaneously scheduled in downlink (DL).

Example 7 may include the method of example 6, wherein the capability indication further indicates a maximum blocker power level for the gap while supporting simultaneous DL scheduling.

Example 8 may include the method of example 6, wherein the capability indication further indicates a first minimum guard band for a first blocker power range, and a second minimum guard band for a second blocker power range.

Example 9 may include the method of example 1, further comprising identifying a guard band configuration received from a base station, and adapting a filter for the gap based at least in part on the guard band configuration.

Example 10 may include a method comprising configuring a user equipment (UE) for measuring adjacent channels operating in a gap between two frequency blocks to be configured for the UE, identifying a report received from the UE, the report indicating a blocker power level for the adjacent channels, determining a configuration of the two frequency blocks for the UE based at least in part on the blocker power level, and configuring the UE in accordance with the determined configuration.

Example 11 may include the method of example 10, wherein configuring the UE for measuring the adjacent channels includes configuring the UE for inter-frequency measurement for the adjacent channels, or configuring the UE for inter-radio access technology (RAT) measurement for the adjacent channels.

Example 12 may include the method of example 10, wherein configuring the UE for measuring the adjacent channels includes configuring the UE to measure a new radio (NR) carrier received signal strength indicator (RSSI) of the adjacent channels, or configuring the UE to measure an evolved universal terrestrial radio access (E-UTRA) carrier RSSI of the adjacent channels.

Example 13 may include the method of example 10, further comprising configuring the UE to periodically report blocker power levels for the adjacent channels, or configuring the UE to report blocker power levels for the adjacent channels when a change in the blocker power levels exceeds a threshold.

Example 14 may include the method of example 10, further comprising generating a blocker power report configuration for transmission to the UE, the blocker power report configuration including a periodic timer information element to configure a periodic timer for the blocker power level reporting, a prohibit timer information element to configure a prohibit timer for the blocker power level reporting, or a power factor change information element to configure a threshold power level difference for the blocker power level reporting.

Example 15 may include the method of example 10, further comprising identifying a capability indication message received from the UE, the capability indication message including an indication of an amount of discontinuous frequency blocks simultaneously schedulable in downlink for the UE, wherein the configuration is determined based at least in part on the amount of discontinuous frequency blocks indicated.

Example 16 may include the method of example 15, wherein the capability indication message further includes a maximum blocker power level for the gap, wherein the configuration is further determined based at least in part on the maximum blocker power level.

Example 17 may include the method of example 15, further comprising configuring a guard band for the gap based at least in part on capability information from the capability indication message and the blocker power level.

Example 18 may include the method of example 15, further comprising scheduling resource block allocations for the UE based at least in part on capability information from the capability indication message and the blocker power level.

Example 19 may include a method comprising generating a capability indication message for transmission to a base station, the capability indication message including an indication of an amount of discontinuous frequency block supported for simultaneous scheduling in downlink (DL), identifying a blocker power level configuration for measuring a blocker power level for adjacent channels operating in a gap between two frequency blocks configurable for a user equipment, determining the blocker power level for the adjacent channels in accordance with the blocker power level configuration, and generating a report that indicates the blocker power level for transmission.

Example 20 may include the method of example 19, wherein determining the blocker power level includes performing a measurement of a received signal strength indicator (RSSI) for the adjacent channels, wherein the blocker power level is determined at least in part on the measured RSSI.

Example 21 may include the method of example 19, wherein the capability indication message further includes a maximum blocker power level for the gap while supporting simultaneous in the DL, or an indication of one or more minimum guard bands for one or more blocker power ranges.

Example 22 may include an apparatus comprising means to perform one or more elements of a method described in or related to any of examples 1-21, or any other method or process described herein.

Example 23 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example 24 may include an apparatus comprising logic, modules, or circuitry to perform one or more elements of a method described in or related to any of examples 1-21, or any other method or process described herein.

Example 25 may include a method, technique, or process as described in or related to any of examples 1-21, or portions or parts thereof.

Example 26 may include an apparatus comprising: one or more processors and one or more computer-readable media comprising instructions that, when executed by the one or more processors, cause the one or more processors to perform the method, techniques, or process as described in or related to any of examples 1-21, or portions thereof.

Example 27 may include a signal as described in or related to any of examples 1-21, or portions or parts thereof.

Example 28 may include a datagram, information element, packet, frame, segment, PDU, or message as described in or related to any of examples 1-21, or portions or parts thereof, or otherwise described in the present disclosure.

Example 29 may include a signal encoded with data as described in or related to any of examples 1-21, or portions or parts thereof, or otherwise described in the present disclosure.

Example 30 may include a signal encoded with a datagram, IE, packet, frame, segment, PDU, or message as described in or related to any of examples 1-21, or portions or parts thereof, or otherwise described in the present disclosure.

Example 31 may include an electromagnetic signal carrying computer-readable instructions, wherein execution of the computer-readable instructions by one or more processors is to cause the one or more processors to perform the method, techniques, or process as described in or related to any of examples 1-21, or portions thereof.

Example 32 may include a computer program comprising instructions, wherein execution of the program by a processing element is to cause the processing element to carry out the method, techniques, or process as described in or related to any of examples 1-21, or portions thereof.

Example 33 may include a signal in a wireless network as shown and described herein.

Example 34 may include a method of communicating in a wireless network as shown and described herein.

Example 35 may include a system for providing wireless communication as shown and described herein.

Example 36 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
performing a measurement of a received signal strength indicator (RSSI) for adjacent channels operating in a gap between two frequency blocks to be configured for a user equipment (UE);
determining a blocker power level based at least in part on the measured RSSI; and
generating a report that indicates the blocker power level for transmission.

2. The method of claim 1, further comprising:
reading a channel bandwidth corresponding to the adjacent channels, wherein the blocker power level is further determined based at least in part on the channel bandwidth.

3. The method of claim 1, further comprising:
performing additional RSSI measurements for the adjacent channels;
determining one or more additional blocker power levels based at least in part on the additional RSSI measurements; and
periodically generating one or more reports indicating the one or more additional blocker power levels for transmission.

4. The method of claim 1, further comprising:
performing an additional RSSI measurement for the adjacent channels;
determining an additional blocker power level based at least in part on the additional RSSI measurement;
determining a difference between the additional blocker power level and the blocker power level;
determining whether the difference exceeds a threshold power level difference; and
determining whether to generate an additional report indicating the additional blocker power level for transmission based at least in part on whether the difference is determined to exceed the threshold power level difference.

5. The method of claim 1, further comprising:
identifying a blocker power report configuration to configure blocker power level reporting, the blocker power report configuration including:
a periodic timer information element to configure a periodic timer for the blocker power level reporting;
a prohibit timer information element to configure a prohibit timer for the blocker power level reporting; or
a power factor change information element to configure a threshold power level difference for the blocker power level reporting.

6. The method of claim 1, further comprising:
generating a capability indication for transmission, the capability indication indicating how many discontinuous frequency blocks can be simultaneously scheduled in downlink (DL).

7. The method of claim 6, wherein the capability indication further indicates a maximum blocker power level for the gap while supporting simultaneous DL scheduling.

8. The method of claim 6, wherein the capability indication further indicates:
a first minimum guard band for a first blocker power range; and
a second minimum guard band for a second blocker power range.

9. The method of claim 1, further comprising:
identifying a guard band configuration received from a base station; and
adapting a filter for the gap based at least in part on the guard band configuration.

10. A method comprising:
generating a blocker power level configuration for transmission to a user equipment (UE) for measuring adjacent channels operating in a gap between two frequency blocks configurable for the UE;
identifying a report received from the UE, the report indicating a blocker power level for the adjacent channels;
determining a configuration of the two frequency blocks for the UE based at least in part on the blocker power level; and
generating, in accordance with the determined configuration, a guard band configuration for transmission to the UE.

11. The method of claim 10, wherein the blocker power level configuration:
configures the UE for inter-frequency measurement for the adjacent channels; or
configures the UE for inter-radio access technology (RAT) measurement for the adjacent channels.

12. The method of claim 10, wherein the blocker power level configuration:
configures the UE to measure a new radio (NR) carrier received signal strength indicator (RSSI) of the adjacent channels; or
configures the UE to measure an evolved universal terrestrial radio access (E-UTRA) carrier RSSI of the adjacent channels.

13. The method of claim 10, further comprising:
configuring the UE to periodically report blocker power levels for the adjacent channels; or
configuring the UE to report blocker power levels for the adjacent channels when a change in the blocker power levels exceeds a threshold.

14. The method of claim 10, further comprising:
generating a blocker power report configuration for transmission to the UE, the blocker power report configuration including:
a periodic timer information element to configure a periodic timer for the blocker power level reporting;
a prohibit timer information element to configure a prohibit timer for the blocker power level reporting; or
a power factor change information element to configure a threshold power level difference for the blocker power level reporting.

15. The method of claim 10, further comprising:
identifying a capability indication message received from the UE, the capability indication message including an indication of an amount of discontinuous frequency blocks simultaneously schedulable in downlink for the UE, wherein the configuration is determined based at least in part on the amount of discontinuous frequency blocks indicated.

16. The method of claim 15, wherein the capability indication message further includes a maximum blocker power level for the gap, wherein the configuration is further determined based at least in part on the maximum blocker power level.

17. The method of claim 15, further comprising:
configuring a guard band for the gap based at least in part on capability information from the capability indication message and the blocker power level.

18. One or more non-transitory, computer-readable media having instructions that, when executed, cause processing circuitry to:
generate a capability indication message for transmission to a base station, the capability indication message including an indication of an amount of discontinuous frequency block supported for simultaneous scheduling in downlink (DL);
identify a blocker power level configuration for measuring a blocker power level for adjacent channels operating in a gap between two frequency blocks configurable for a user equipment;
determine the blocker power level for the adjacent channels in accordance with the blocker power level configuration; and
generate a report that indicates the blocker power level for transmission.

19. The one or more non-transitory, computer-readable media of claim 18, wherein to determine the blocker power level includes to:
perform a measurement of a received signal strength indicator (RSSI) for the adjacent channels, wherein the blocker power level is determined at least in part on the measured RSSI.

20. The one or more non-transitory, computer-readable media of claim 18, wherein the capability indication message further includes:
a maximum blocker power level for the gap while supporting simultaneous in the DL; or
an indication of one or more minimum guard bands for one or more blocker power ranges.
